(19) United States
(12) Patent Application Publication
(10) Pub. No.: US 2024/0056729 A1
(43) Pub. Date: Feb. 15, 2024

(54) Vehicle Sensor Device with Integrated Ultrasonic Sensor and Microphone

(71) Applicant: HARMAN INTERNATIONAL INDUSTRIES, INCORPORATED, Stamford, CT (US)

(72) Inventors: Viktor DOBOS, Kecskemét (HU); Zsolt MARTON, Zalaegerszeg (HU); Marco Salvatore RIEMANN, Munich (DE); Szabolcs Levente DITROI-TOTH, Vác (HU)

(73) Assignee: HARMAN INTERNATIONAL INDUSTRIES, INCORPORATED, Stamford, CT (US)

(21) Appl. No.: 18/232,614

(22) Filed: Aug. 10, 2023

(30) Foreign Application Priority Data
Aug. 12, 2022 (EP) 22190193.7

(51) Int. Cl. H04R 1/34; G10K 11/18; H04R 1/08

(52) U.S. Cl. CPC H04R 1/342; G10K 11/18; H04R 1/083; H04R 2499/13

(57) ABSTRACT

A vehicle sensor device comprising an ultrasonic sensor, a microphone arranged next to or behind the ultrasonic sensor and an acoustic channel to the microphone arranged between the microphone and the ultrasonic sensor.

### CROSS-REFERENCE TO RELATED APPLICATIONS

This application claims priority to EP application Serial No. EP 22190193.7 filed Aug. 12, 2022, the disclosure of which is hereby incorporated in its entirety by reference herein.

### TECHNICAL FIELD

The present disclosure relates to a vehicle sensor device.

### BACKGROUND

External sensors provide an increasing number of functionalities to vehicles, in particular to connected cars and autonomous (driving) vehicles.

For example, sound from the outside of a vehicle originating e.g. from emergency vehicles, pedestrians or events happening in the surrounding of a vehicle may be detected using microphones on the exterior body or surface of a vehicle. As another example, echolocation sensors are usually required for parking assistance systems.

Thus, vice versa, the number of sensors mounted in particular to the exterior of a vehicle is increasing. Therefore there is a need for techniques to integrate a plurality of sensors to the exterior of a vehicle.

### SUMMARY

A first aspect of the present disclosure relates to a vehicle sensor device. The vehicle sensor device includes an ultrasonic sensor, a microphone arranged next to or behind the ultrasonic sensor and an acoustic channel to the microphone arranged between the microphone and the ultrasonic sensor.

The vehicle sensor device may be installed at the outside of a vehicle, e.g. at the front or rear bumper. A microphone, e.g. used for navigation, voice commands, or noise cancelling purposes, and an ultrasonic sensor, e.g. used for parking assistance, are placed such that the microphone is behind or next to the ultrasonic sensor and such that an acoustic channel towards to microphone is arranged between the microphone and the ultrasonic sensor.

Thereby, space and resources may be saved whilst maintaining sensor signal quality. Further, the microphone may be protected against mechanical damage or (air) pollution by the ultrasonic sensor.

In an embodiment, the ultrasonic sensor and the microphone are attached to and/or arranged in a supporting element. In other words: The ultrasonic sensor and the microphone are attached to, i.e. share, a common supporting element. Thereby, the relative arrangement of the microphone and the ultrasonic sensor is fixed and the acoustic channel may be formed and maintained constant. This geometry ensures unhindered functioning of both sensors whilst providing both sensors in a compact design, thereby saving space and resources.

According to another embodiment, the supporting element is at least part of a housing of the microphone, a part of a housing of the vehicle sensor device and/or a part of a vehicle, in particular a bumper of a car, or a conically formed element attachable to the vehicle or the bumper. If the supporting element is part of the housing of the microphone, the vehicle sensor device may form a compact, attachable, space saving module that may be compatible to conventional car bumpers that are configured to hold an ultrasonic sensor. Such bumpers may include an opening into which the vehicle sensor device may be attached. Alternatively or additionally, the supporting element of the vehicle sensor device may be part of the vehicle, e.g. part of the bumper of the vehicle enabling improved compatibility between the geometry of the vehicle sensor device and the vehicle. Alternatively or additionally, the supporting element may be a conically formed element attachable to the vehicle or the bumper. The element may be configured to match the geometry of its counterpart to ensure firm fit between the elements.

In an embodiment, the vehicle sensor device is attachable and/or included in a vehicle, in particular a bumper of a car. Thereby, the microphone and ultrasonic sensor may be fixed to the vehicle in a space saving and weight saving manner. Further, the positions of the sensors may be defined. For example, if the vehicle sensor device, and in particular the ultrasonic sensor, is incorporated into the bumper, a reduced vehicle sensor device size is enabled.

According to another embodiment, the ultrasonic sensor has a front side and a back side and a front side of the microphone faces the backside of the ultrasonic sensor. Thereby, the front side of the microphone, which may include an acoustic port, may face the acoustic channel next to the ultrasonic sensor and between the ultrasonic sensor and the microphone. Acoustic waves may propagate towards the front of the microphone where they may be detected. In this manner, an opening in the vehicle for the ultrasonic sensor may at the same time be used as an opening for the microphone, allowing the acoustic waves to from the outside of the vehicle to be detected by the microphone. In addition, the microphone is protected by the ultrasonic sensor against damage and/or dirt.

In an embodiment, the acoustic channel extends between the supporting element and a front side of the microphone facing the backside of the ultrasonic sensor. The channel enables free transmission of acoustic signal towards the microphone.

In another embodiment, the acoustic channel includes, e.g. is formed by, a gap between the ultrasonic sensor and the supporting element, and/or a gap between the front side of the microphone and the backside of the ultrasonic sensor. The channel enables free transmission of acoustic signal towards the microphone whilst ensuring a small form factor of the vehicle sensor device.

In an embodiment, the microphone includes an acoustic port and wherein the acoustic port faces the back side of the ultrasonic sensor. This enables acoustic signal propagation within the microphone in a compact design, saving space within the vehicle sensor device and thereby allowing for a small size or form factor of the vehicle sensor device.

In another embodiment, the microphone includes an acoustic port and wherein the acoustic port is located next to the ultrasonic sensor. The acoustic port being located next to the ultrasonic sensor may enable, in particular improve, signal propagation towards and within the microphone.

In an embodiment, the ultrasonic sensor is located inside an opening of the supporting element. For example, the ultrasonic sensor may be located inside an opening in a bumper of a car. Alternatively or additionally, the ultrasonic sensor may be located inside an opening of a supporting element forming part of the housing of the microphone or of the vehicle sensor device. The opening may act as a resonator of the ultrasonic sensor.

In another embodiment, the opening of the supporting element is conically shaped and/or wherein an inner diameter of the opening decreases towards the microphone, in particular along the acoustic channel. The conical shape of the opening enables a directional acoustic signal toward the inner of the housing and thereby improved signal propagation towards the microphone. Additionally, the conical shape, in particular with the ultrasonic sensor being placed concentrically inside the opening, allows to shield the microphone, in particular the membrane of the microphone, against mechanical stress such as produced by water jet streams or particles. Moreover, the shape of the opening facilitates cleaning of the opening and the ultrasonic sensor located therein.

According to an embodiment, the microphone includes a housing. The housing may be attached to or include the supporting element.

In an embodiment, the housing includes a conically and/or cylindrically shaped cavity forming the acoustic port. The shape of the cavity enables acoustic signal transmission toward the membrane and within the microphone.

According to another embodiment, the housing is located at and/or attached to the supporting element and faces an opening, in particular the above mentioned opening. The position of the housing enables a compact design. For example, the supporting element, in particular the bumper of a car, may hold the housing at a fixed position. The orientation of the housing facing the opening of the supporting element allows for unhindered acoustic signal transmission towards the microphone.

### BRIEF DESCRIPTION OF THE DRAWINGS

The features, objects, and advantages of the present disclosure will become more apparent from the detailed description set forth below when taken in conjunction with the drawings in which like reference numerals refer to similar elements.

FIG. 1 depicts a schematic of a vehicle sensor device in a cross sectional view, according to one or more embodiments;

FIG. 2 depicts a schematic of the vehicle sensor device in a tilted three-dimensional view, according to one or more embodiments;

FIG. 3 depicts a schematic of the vehicle sensor device attached to a bumper of a car in a cross sectional view, according to one or more embodiments;

FIG. 4 depicts a schematic of an acoustic path inside the vehicle sensor device in a cross sectional view, according to one or more embodiments;

FIG. 5 depicts a schematic of the vehicle sensor device attached to a bumper of a car in a tilted three-dimensional view, according to one or more embodiments.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

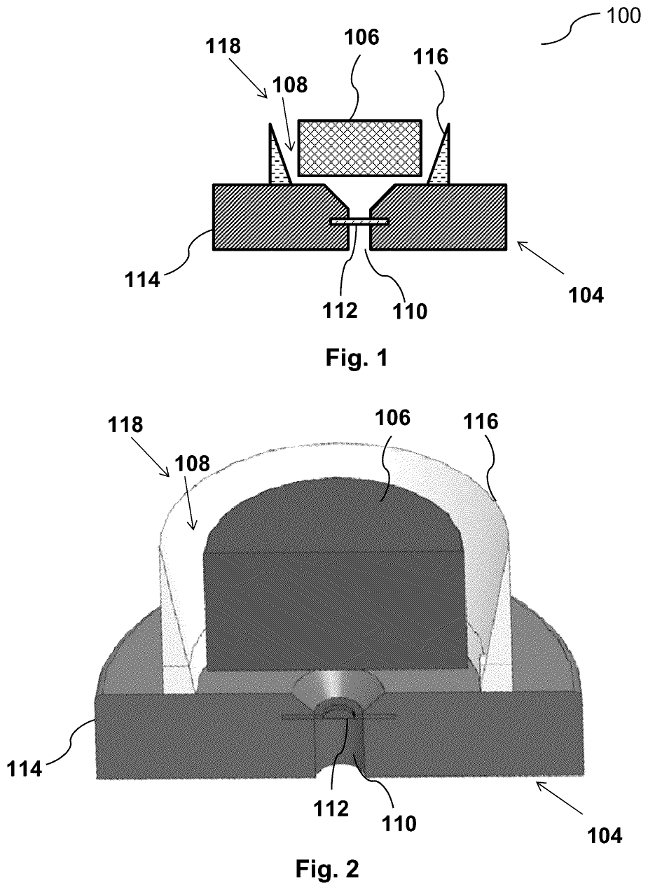

FIGS. 1 and 2 depict a schematic of a vehicle sensor device 100. The vehicle sensor device 100 includes a microphone 104, an ultrasonic sensor 106 and a supporting element 116.

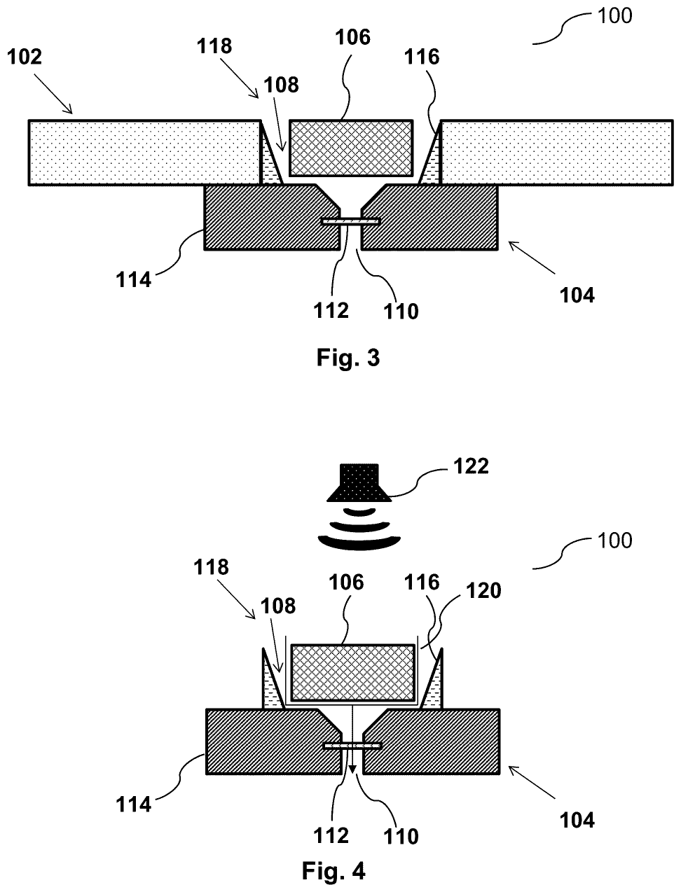

The supporting element 116 may include, e.g. be made of a metallic, polymeric or composite material. The supporting element 116 may be detachably mountable to the exterior of a vehicle or may be part of a vehicle. For example, the supporting element 116 may be mountable to a front and/or a rear bumper 102 of a car, as shown in FIG. 3. The illustrated bumper 102 represents a part of a vehicle 102, in particular a part of a bumper 102, to which the vehicle sensor device 100 is attached, or in which the vehicle sensor device 100 is included. In another embodiment, the part of the vehicle 102 is a different part of a vehicle. Additionally, or alternatively, the part of the vehicle 102 may include the supporting element 116.

The part of the vehicle 102 and/or the supporting element 116 may represent or include a resonator. The resonator may be a resonator for the ultrasonic sensor 106 and attenuate air conducted sound waves, thereby helping the sensor to pick up more mechanic vibration for the same acoustic stimulus.

The ultrasonic sensor 106 may be a disk shaped sensor made of crystalline or ceramic piezoelectric material. The ultrasonic sensor 106 may include, in particular consists of an echolocation sensor that is attached to a rigid cylindrically shaped resonator.

The ultrasonic sensor 106 is mounted at as few places as possible inside the opening 118 of the supporting element 116 to leave a gap forming the acoustic channel 108. For example, the ultrasonic sensor 106 is pointwise fastened (not shown) to the supporting element 116 and/or to the microphone 104. The opening 118 is conically shaped with a decreasing diameter towards the microphone 104.

The microphone 104 may be a MEMS microphone. The microphone 104 may be single microphone or a microphone array. The microphone 104 may be an analog to digital, A2B, microphone. The microphone 104 may have a bottom port and/or a top port. The microphone 104 may be a uni-directional or omni-directional microphone. The microphone 104 includes a housing 114 with a cavity forming an acoustic port 110 and a membrane or diaphragm 112. The acoustic port 110 may be conically and/or cylindrically shaped. The microphone 104 is arranged facing, with its front side, the back side of the ultrasonic sensor 106. The acoustic port 110 faces the back side of the ultrasonic sensor 106. Alternatively, the acoustic port 110 may be located next to the ultrasonic sensor 106, in particular at least in part next to the opening 118.

The housing 114 of the microphone 104 is attached to the supporting element 116 or part of the supporting element 116. Alternatively, the housing 114 of the microphone 104 may be attached to the part of the vehicle 102, e.g. the bumper 102 of a car.

FIG. 4 depicts an acoustic path 120 from an acoustic source 122 through an acoustic channel 108 within the supporting element 116, in particular between the ultrasonic sensor 106 and the microphone 104, to the microphone 104. The acoustic channel 108 extends between the supporting element 116 and the front side of the microphone 104 facing the backside of the ultrasonic sensor 106. The acoustic channel 108 is formed by a gap between the ultrasonic sensor 106 and the supporting element 116 and a gap between the front side of the microphone 104 and the backside of the ultrasonic sensor 106. The acoustic path 120 propagates from the acoustic channel 108 to the acoustic port 110 of the microphone 104.

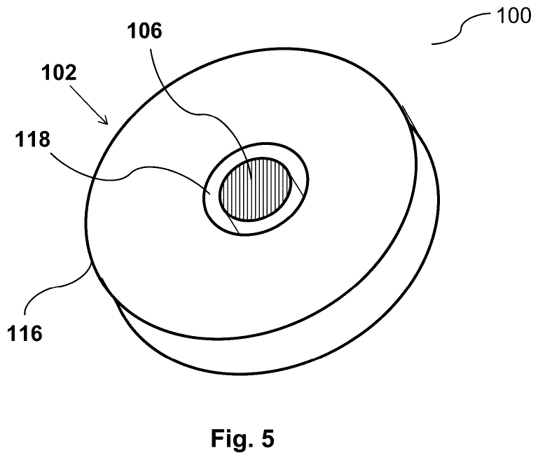

FIG. 5 depicts a tilted front view of the ultrasonic sensor 106 inside the opening 118 of the supporting element 116. In this example, the supporting element 116 is formed by a part of a vehicle 102, e.g. a bumper 102 of a car. A gap is formed between the ultrasonic sensor 106 and the part of the vehicle 102. The ultrasonic sensor 106 is attached to the part of the vehicle 102 such that the gap remains at least substantially open, in particular at as many places as possible, allowing for acoustic waves to enter the acoustic channel 108 and to reach the microphone 104 arranged behind the ultrasonic sensor 106. Further, the ultrasonic sensor 106 is attached to the part of the vehicle 102 such that the resonator included in the supporting element 116 or the part of the vehicle 102 is not hindered.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.

### REFERENCE SIGNS

100 Vehicle sensor device
102 Part of a vehicle
104 Microphone
106 Ultrasonic sensor
108 Acoustic channel
110 Acoustic port
112 Membrane
114 Housing of the microphone
116 Supporting element
118 Opening
120 Acoustic path
122 Acoustic source

What is claimed is:

1. A vehicle sensor device comprising:
an ultrasonic sensor;
a microphone arranged adjacent to the ultrasonic sensor; and
an acoustic channel to the microphone arranged between the microphone and the ultrasonic sensor.

2. The vehicle sensor device of claim 1, wherein the ultrasonic sensor and the microphone are attached to a supporting element.

3. The vehicle sensor device of claim 2, wherein the supporting element is at least a part of a housing of the microphone.

4. The vehicle sensor device of any of claim 2, wherein the acoustic channel extends between the supporting element and a front side of the microphone facing a backside of the ultrasonic sensor.

5. The vehicle sensor device of claim 2, wherein the acoustic channel defines a gap between the ultrasonic sensor and the supporting element.

6. The vehicle sensor device of claim 2, wherein the ultrasonic sensor is located inside an opening of the supporting element.

7. The vehicle sensor device of claim 6, wherein the opening of the supporting element is conically shaped and/or wherein an inner diameter of the opening decreases towards the microphone, in particular along the acoustic channel.

8. The vehicle sensor device of claim 2, wherein the microphone comprises a housing.

9. The vehicle sensor device of claim 8, wherein the housing comprises one of a conically and cylindrically shaped cavity forming the acoustic port.

10. The vehicle sensor device of claim 8, wherein the housing is located at the supporting element, and faces an opening defined by the supporting element.

11. The vehicle sensor device of claim 1, wherein the vehicle sensor device is attachable to a vehicle.

12. The vehicle sensor device of claim 1, wherein the ultrasonic sensor has a front side and a back side, wherein a front side of the microphone faces the back side of the ultrasonic sensor.

13. The vehicle sensor device of claim 1, wherein the microphone comprises an acoustic port and wherein the acoustic port faces the back side of the ultrasonic sensor.

14. The vehicle sensor device of claim 1, wherein the microphone comprises an acoustic port and wherein the acoustic port is located adjacent to the ultrasonic sensor.

15. A vehicle sensor device comprising:
an ultrasonic sensor;
a microphone having a housing and arranged behind the ultrasonic sensor; and
an acoustic channel to the microphone arranged between the microphone and the ultrasonic sensor,
the housing including a supporting element, wherein the ultrasonic sensor and the microphone are arranged in the supporting element.

16. A vehicle sensor device comprising:
an ultrasonic sensor;
a microphone arranged behind the ultrasonic sensor; and
an acoustic channel to the microphone arranged between the microphone and the ultrasonic sensor,
a supporting element forming at least part of a bumper of a vehicle, wherein the ultrasonic sensor and the microphone are arranged in the supporting element.

17. The vehicle sensor device of claim 16, wherein the ultrasonic sensor has a front side and a back side, wherein a front side of the microphone faces the back side of the ultrasonic sensor.

18. The vehicle sensor device of claim 16, wherein the acoustic channel defines a gap between the front side of the microphone and a backside of the ultrasonic sensor.

19. The vehicle sensor device of claim 16, wherein the microphone comprises an acoustic port and wherein the acoustic port faces the back side of the ultrasonic sensor.

20. The vehicle sensor device of claim 10, wherein the support element defines an opening, the ultrasonic sensor arranged inside the opening and wherein an inner diameter of the opening decreases towards the microphone, in particular along the acoustic channel.
